(19) United States
(12) Patent Application Publication
(10) Pub. No.: US 2006/0078768 A1
(43) Pub. Date: Apr. 13, 2006

(54) Anode inlet unit for a fuel cell system

(76) Inventors: Rainer Pechtold, Russelsheim (DE); Jens-Uwe Sparschuh, Nackenheim (DE)

Correspondence Address: CARY W. BROOKS;General Motors Corporation, Mail Code 482-C23-B21, P.O. Box 300, Detroit, MI, 48265-3000, US

(21) Appl. No.: 10/960,472

(22) Filed: Oct. 7, 2004

(51) Int. Cl. H01M 8/04

(52) U.S. Cl. 429/22; 429/34; 429/13

(57) ABSTRACT

A fuel cell system that employs one or more injectors in an anode inlet unit for providing hydrogen flow control to a fuel cell stack in the system. At a low flow rate, the duty cycle of one of the injectors is controlled and the other injectors are closed. As the flow rate requirements increase, the duty cycle of the first injector is increased until it is completely open. The duty cycles of the other injectors are then controlled in the same manner in succession. The anode inlet unit may include a valve for directing the hydrogen supply gas to other devices in the fuel cell system. Additionally, a valve can be provided in the unit that receives a flow of air to purge the anode side of the fuel cell stack.

### BACKGROUND OF THE INVENTION

1. Field of the Invention

This invention relates generally to a fuel cell system and, more particularly, to a fuel cell system that includes an anode inlet unit having one or more injectors for controlling the flow of a hydrogen anode input gas to a fuel cell stack in the system.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. A PEMFC generally includes a solid polymer electrolyte proton conducting membrane, such as a perfluorosulfonic acid membrane. The anode and cathode typically include finely divided catalytic particles, usually platinum (Pt). The catalytic mixture is deposited on opposing sides of the membrane. The combination of the anode catalytic mixture, the cathode catalytic mixture and the membrane define a membrane electrode assembly (MEA). MEAs require certain conditions for effective operation, including proper water management and humidification.

Several fuel cells are typically combined in a fuel cell stack to generate the desired power. For example, a typical fuel cell stack for a vehicle may have two hundred stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The pressure within the fuel cell stack is controlled to maintain a desired membrane relative humidity for efficient stack operation. Changes in the temperature of the stack require that the pressure within the stack also be changed to maintain the desired relative humidity. This requires an increase or decrease in the flow rate of hydrogen to the stack to change the pressure. Also, as the fuel cell stack generates electricity, hydrogen is consumed, also requiring more hydrogen flow to maintain the pressure within the stack.

In an automotive application, the hydrogen is typically stored in a tank on the vehicle. FIG. 1 is a plan view of a fuel cell system 10 including a hydrogen tank 12 for storing hydrogen. The hydrogen gas from the hydrogen tank 12 is applied to a fuel cell stack 14 through a flow controller 16. A system controller 18 controls the flow controller 16 to control the flow rate of the hydrogen gas for the reasons discussed above.

Various devices are known in the art that can be used for the flow controller 16, including electromagnetic controlled proportional valves. The control of a proportional valve for this purpose is fairly complicated because different operating conditions of the stack, such as power demand from the stack, temperature of the stack, etc., may require a large difference in the flow rate volume of the anode input gas. Further, the output pressure of the tank 12 is not steady, and is independent of the flow rate. Thus, a proportional valve may not be as effective for controlling the hydrogen flow rate as desired for automotive applications.

Most proportional valves have an orifice that is opened and closed a certain amount to control the flow through the valve. Electromagnetically controlled proportional valves thus have a built-in hysteresis that complicates the control. A sensor can be provided in combination with the proportional valve for feedback purposes to control the hysteresis. However, the sensor adds cost to the system and requires that the sensor be sealed to prevent hydrogen from leaking to the environment. Also, proportional valves cannot generally provide a quick enough change in flow rate for automotive applications.

Further, a typical proportional valve has a flow rate range or turn-down ratio of about 1:10. More expensive proportional valves can provide a turn-down ratio of 1:20. However, for an automotive fuel cell application, the turn-down ratio may need to be significantly higher, possibly on the order of 1:50. For example, low flow rates at low stack pressure and high tank pressure and high flow rates at high stack pressure and low tank pressure provides this wide range of possible conditions. Therefore, other flow control devices may be required for more effectively controlling the flow rate of the anode gas to the fuel cell stack in a fuel cell system.

### SUMMARY OF THE INVENTION

In accordance with the teachings of the present invention, a fuel cell system is disclosed that employs one or more injectors in an anode inlet unit that provides hydrogen gas flow control to a fuel cell stack in the system. In one embodiment, a plurality of injectors is employed to provide the desired flow rate to the fuel cells in the fuel cell stack. At a low flow rate, the duty cycle of one of the injectors is controlled and the other injectors are closed. As the flow rate requirements increase, the duty cycle of the first injector is increased until it is completely open. The duty cycles of the other injectors are then controlled in the same manner in succession.

In another embodiment of the present invention, the anode inlet unit includes another injector or flow regulation valve for directing the hydrogen supply gas to other devices in the fuel cell system. Additionally, an injector or other valve can be provided in the unit that receives a flow of air that can be directed to the anode side of the stack when no hydrogen is flowing to purge the anode side.

Additional advantages and features of the present invention will become apparent from the following description and appended claims, taken in conjunction with the accompanying drawings.

### BRIEF DESCRIPTION OF THE DRAWINGS

FIG. 1 is a plan view of a fuel cell system employing a flow controller, according to an embodiment of the present invention;

FIG. 2 is a cross-sectional view of an injector that can be used in the flow controller shown in FIG. 1;

FIG. 3 is a schematic plan view of an anode inlet unit employing a plurality of injectors and other valves that can be used for the flow controller shown in FIG. 1, according to another embodiment of the present invention; and

FIG. 4 is a schematic plan view of an anode inlet unit for two fuel cell stacks in a fuel cell system that employs injectors and other valves, according to another embodiment of the present invention.

### DETAILED DESCRIPTION OF THE EMBODIMENTS

The following discussion of the embodiments of the invention directed to an anode inlet unit employing one or more injectors in a fuel cell system is merely exemplary in nature, and is in no way intended to limit the invention or its applications or uses. For example, the discussion herein is for an anode inlet unit associated with a fuel cell system on a vehicle. However, the anode inlet unit may have application for other fuel cell systems for other applications.

According to the invention, the flow controller 16 includes one or more injectors that control the flow of hydrogen from the hydrogen tank 12 to the fuel cell stack 14. As is well known in the art, an injector is a valve that switches between a fully opened and a fully closed position at a particular frequency and duty cycle. The frequency of the injector determines the time of each switching cycle of the injector, and the duty cycle of the injector determines how long the injector is open and closed per cycle. Therefore, the ratio of time between the open and close position of the injector is the duty cycle. Thus, instead of controlling the flow by geometry as was done by the proportional valves, the present invention controls the flow by time. The injector can be operated at a constant frequency. However, for low duty cycles, it may be desirable to decrease the frequency because low duty cycles can be adjusted more precisely at low frequency to increase the injector's turn-down ratio.

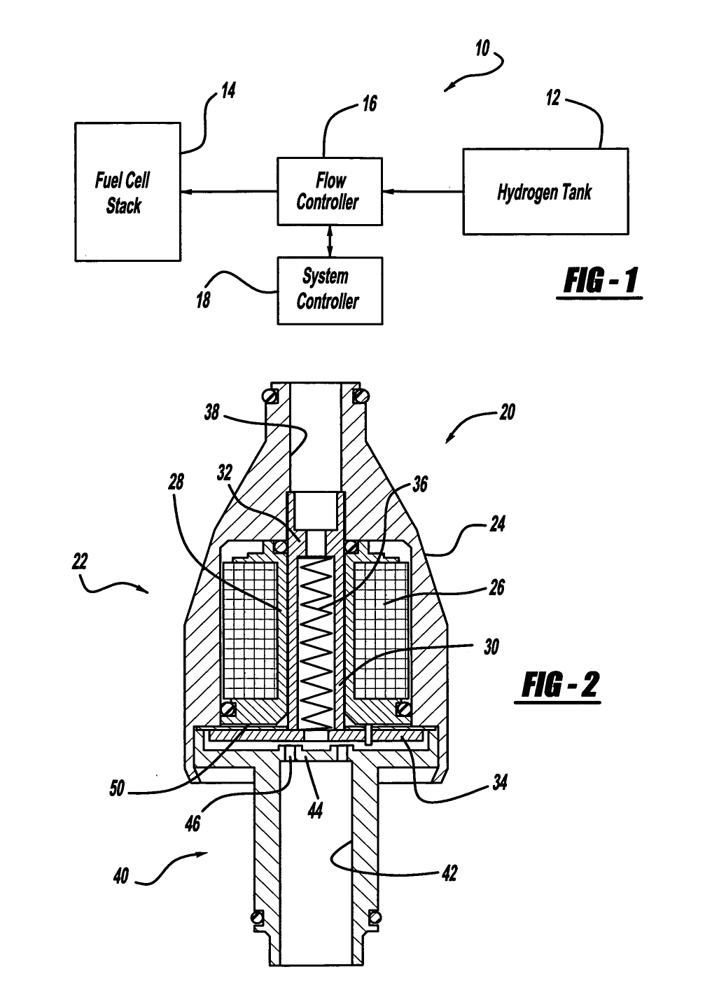

FIG. 2 is a cross-sectional view of an injector 20 that can be used as the flow controller 16. The injector 20 includes an electromagnetic portion 22 having an outer housing or can 24. An electromagnetic coil 26 is wound on a cylindrical bobbin 28 positioned within the can 24, and an elongated cylindrical magnetic pole piece 30 is positioned within a chamber 38 within the can 24 concentric with the bobbin 28. An annular armature 34 is provided below the electromagnetic coil 26. A spring 36 is positioned within the pole piece 30 between a shoulder 32 of the pole piece 30 and the armature 34. The injector 20 also includes a valve portion 40 having a cylindrical chamber 42. An annular valve piece 44 is provided within the chamber 42 adjacent to the armature 34, as shown. A spring member 50 is provided between the can 24 and the armature 34, as shown.

When no electrical current is provided to the coil 26, the spring 34 forces the armature 34 down so it seats against the valve piece 44 closing off the chambers 32 and 42 so that no flow is provided. By applying an electrical current to the coil 26, the armature 34 is drawn towards the pole piece 30 by magnetic interaction against the bias of the spring 36 so that it lifts off of the valve piece 44 allowing flow between the chambers 38 and 42 through a ring aperture 46. This position is shown in FIG. 2. Pulses of the electrical current applied to the coil 26 set the duty cycle of the injector 20. The injector 20 is one example of an injector suitable for the flow controller 16. Other injectors may be equally suitable. For example, the location of the spring 36 can be changed and the aperture 46 can be modified to be one or more holes.

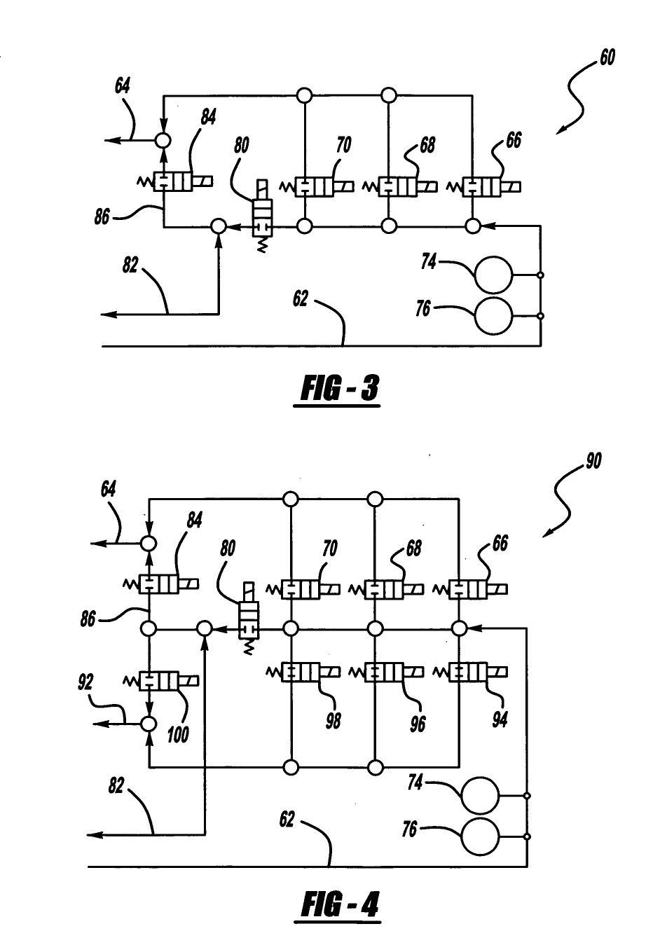

FIG. 3 is a schematic plan view of an anode inlet unit 60, according to the invention, that can be used for the flow controller 16 in the fuel cell system 10. Hydrogen from the hydrogen tank 12 is provided to the anode inlet unit 60 on a line 62, and a controlled flow of hydrogen is provided to the fuel cell stack 14 on a line 64 to control the pressure within the stack 14. A series of three injectors 66, 68 and 70, for example three of the injectors 20, provide the flow rate control by selectively controlling the duty cycle and the frequency of the injectors 66-70 with signals from the controller 18. Particularly, the controller 18 controls the flow of hydrogen from the input line 62 to the output line 64 for the desired flow rate for a particular operating condition of the stack 14 by sequentially increasing the duty cycles of the injector 66-70 from a minimum flow rate to a maximum flow rate.

At low flow rates, the controller 18 closes the injectors 68 and 70 and selectively increases the duty cycle of the injector 66 as the hydrogen flow rate demand increases. When the duty cycle of the injector 66 reaches 100 percent (continuously open), then the controller 18 selectively increases the duty cycle of the injector 68 as the hydrogen flow rate demand increases. This process continues as the demand increases until all three of the injectors 66-70 have a 100 percent duty cycle, providing a maximum hydrogen flow rate. By this technique, the anode inlet unit 60 can provide a demanded hydrogen flow rate quickly and accurately without suffering the drawbacks of proportional valves discussed above, regardless of the hydrogen tank pressure. The use of three injectors is by way of a non-limiting example in that other applications may require more or less injectors for this purpose.

A pressure sensor 74 and a temperature sensor 76 are provided in the hydrogen input line 62, or other suitable location, to provide pressure and temperature signals to the controller 18 and provide a more accurate flow rate. Other sensors can also be provided in the inlet unit 60 as may be required.

Further, an injector or other valve 80, such as a 2/2-way valve, is provided in the input line 62 to selectively direct some of the hydrogen from the tank 12 to other components in the fuel cell system 10 on a line 82. The hydrogen can be directed to the cathode side of the stack 14 to be mixed with air to provide combustion in the cathode side to heat the stack 14 during cold starts.

Further, an injector or other valve 84, such as a 2/2-way valve, is provided in a line 86 coupled to the output line 64 so that air on the line 82 can be selectively directed into the line 64 to purge the anode side of the stack 14 when the hydrogen flow to the anode side is shut off. This purging pushes water out of the stack 14 that may otherwise freeze in the stack 14. The controller 18 selectively controls the valves 80 and 84 so that the line 82 is only being used for one purpose at a time.

FIG. 4 is a schematic plan view of an anode inlet unit 90, according to another embodiment of the present invention, where like elements are identified by the same reference numeral as the anode inlet unit 60. The anode inlet unit 90 can be used for fuel cell systems that include two stacks where a controlled hydrogen flow is provided to the second stack on an output line 92. Three injectors 94, 96 and 98 are used to control the flow to the output line 92 in the manner as discussed above. Further, an injector or other valve 100, such as a 2/2-way valve, is provided to direct input air into the anode side of the second stack as discussed above.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a hydrogen source;
a fuel cell stack; and
a hydrogen inlet unit responsive to a flow of hydrogen from the hydrogen source and providing a controlled flow of hydrogen from the hydrogen source to the fuel stack at a desired flow rate, said inlet unit including at least one injector having a duty cycle that sets the flow rate to the fuel cell stack.

2. The fuel cell system according to claim 1 wherein the at least one injector is three injectors that are sequentially controlled to increase or decrease the hydrogen flow rate to the fuel cell stack.

3. The fuel cell system according to claim 1 further comprising a valve for directing a hydrogen flow to another component in the fuel cell system other than an anode side of the fuel cell stack.

4. The fuel cell system according to claim 1 further comprising a valve that is responsive to an input airflow for purging an anode side of the fuel cell stack.

5. The fuel cell system according to claim 1 wherein the at least one injector is a plurality of injectors where at least one of the injectors directs a controlled flow to the fuel cell stack and at least one other injector directs a flow of hydrogen to another fuel cell stack.

6. The fuel cell system according to claim 1 wherein the hydrogen source is a hydrogen tank for storing hydrogen.

7. The fuel cell system according to claim 6 wherein the fuel cell system is on a vehicle.

8. A fuel cell system for a vehicle, said system comprising:
a hydrogen tank for storing hydrogen;
a fuel cell stack; and
a hydrogen inlet unit responsive to a flow of hydrogen from the hydrogen tank and providing a controlled flow of hydrogen from the hydrogen tank to the fuel stack at a desired flow rate, said inlet unit including a plurality of injectors having duty cycles that set the flow rate to the fuel cell stack.

9. The fuel cell system according to claim 8 wherein the at least one injector is three injectors that are sequentially controlled to increase or decrease the hydrogen flow rate to the fuel cell stack.

10. The fuel cell system according to claim 8 further comprising a valve for directing a hydrogen flow to another component in the fuel cell system other than an anode side of the fuel cell stack.

11. The fuel cell system according to claim 8 further comprising a valve that is responsive to an input airflow for purging an anode side of the fuel cell stack.

12. The fuel cell system according to claim 8 wherein the plurality of injectors includes a plurality of injectors for direct a controlled flow to the fuel cell stack and a plurality of other injector for directing a flow of hydrogen to another fuel cell stack.

13. A method for controlling the flow of a hydrogen gas to a fuel cell stack, said method comprising:
providing at least one injector;
providing a pressurized flow of hydrogen gas to the at least one injector; and
controlling the duty cycle of the at least one injector to control the flow rate of hydrogen gas from the injector to the fuel cell stack.

14. The method according to claim 13 wherein providing at least one injector includes providing a plurality of injectors and wherein controlling the duty cycle of the at least one injector includes sequentially controlling the duty cycle of the plurality of injectors to control the flow rate of hydrogen gas from the injector to the fuel cell stack.

15. The method according to claim 14 wherein providing at least one injector includes providing three injectors.

16. The method according to claim 13 further comprising providing a valve for directing a hydrogen flow to another component in the fuel cell system other than an anode side of the fuel cell stack.

17. The method according to claim 13 further comprising providing a valve that is responsive to an input airflow for purging an anode side of the fuel cell stack.

18. The method according to claim 13 wherein providing at least one injector includes providing a plurality of injectors where some of the injectors control the hydrogen gas flow to the fuel cell stack and some of the injectors control a hydrogen flow to another fuel cell stack.

19. The method according to claim 13 wherein providing a flow of hydrogen gas to the at least one injector includes providing a flow of hydrogen gas to the at least one injector from a hydrogen tank.

20. The method according to claim 19 wherein the hydrogen tank is on a vehicle.
